(19) United States
(12) Patent Application Publication
(10) Pub. No.: US 2026/0216873 A1
(43) Pub. Date: Jul. 30, 2026

(54) ROBOTIC AIRPORT BAGGAGE HANDLING SYSTEM

(71) Applicant: Dexterity, Inc., Redwood City, CA (US)

(72) Inventors: Vikas Agrawal, Santa Clara, CA (US); Yue Shi, San Mateo, CA (US); Samir Menon, Atherton, CA (US)

(21) Appl. No.: 19/314,826

(22) Filed: Aug. 29, 2025

Related U.S. Application Data
(60) Provisional application No. 63/688,699, filed on Aug. 29, 2024.

(51) Int. Cl. B25J 9/16; B25J 5/00; B25J 15/06; B64F 1/32

(52) U.S. Cl. CPC B25J 9/1669; B25J 9/1697; B25J 15/0616; B64F 1/324; B25J 5/007

(57) ABSTRACT

A robotic baggage handlings system is disclosed. The system receives data from one or more sensors and uses sensor data received from the one or more sensors to generate a three-dimensional view of a baggage handling workspace to generate and implement a plan to use one or more robotic arms to pick and place baggage items as needed to do one or both of (1) load baggage items from a first baggage conveyor into or onto a trolley, Unit Load Device (ULD), or other container; and (2) remove baggage items from a trolley, Unit Load Device (ULD), or other container and place each on a second baggage conveyor.

### CROSS REFERENCE TO OTHER APPLICATIONS

This application claims priority to U.S. Provisional Ser. No. 63/688,699 entitled ROBOTIC AIRPORT BAGGAGE HANDLING SYSTEM filed Aug. 29, 2024 which is incorporated herein by reference for all purposes.

### BACKGROUND OF THE INVENTION

Airport baggage handling typically relies on human workers to transfer bags between conveyors that route baggage within an airport, e.g., transferring bags from check in areas to baggage handling areas in which bags are sorted, typically by hand, into trolleys and/or containers (e.g., Unit Load Devices or ULDs) or, conversely, removing bags from a trolley or ULD and placing them on a baggage handling conveyor in a baggage handling area for transport to a baggage claim area.

Typically, human workers use their hands to load and unload baggage/cargo, which is not ideal because people need to lift heavy weights and need to do repeated lifting/bending/placing actions which result in medical issues, inconsistency in meeting KPIs etc.

### BRIEF DESCRIPTION OF THE DRAWINGS

Various embodiments of the invention are disclosed in the following detailed description and the accompanying drawings.

FIG. 1A is a diagram illustrating an embodiment of a robotic system to handle baggage.

FIG. 1B is a diagram illustrating an embodiment of a robotic system to handle baggage.

FIG. 2A illustrates an example of a partially loaded Unit Load Device (ULD).

FIG. 2B shows a perspective view of a ULD on or comprising a mobile base.

FIG. 2C illustrates an example of ULDs loaded in the cargo holds of an aircraft, shown in cross-section.

FIG. 3A is a diagram illustrating an embodiment of a robotic system to handle baggage.

FIG. 3B is a diagram illustrating an embodiment of a robotic system to handle baggage.

FIG. 3C is a diagram illustrating an embodiment of a robotic system to handle baggage.

FIG. 3D is a diagram illustrating an embodiment of a robotic system to handle baggage.

FIG. 4A is a diagram illustrating a robotic arm shoulder positioning mechanism used in an embodiment of a robotic system to handle baggage.

FIG. 4B is a diagram illustrating an embodiment of a robotic system to handle baggage that incorporates a robotic arm shoulder positioning mechanism for each of two robotic arms.

FIG. 5 is a diagram illustrating an embodiment of a robotic system to handle baggage that includes robotic arms having dissimilar types of end effector.

FIGS. 6A-6C illustrate embodiments of a robotic end effector to handle baggage.

FIGS. 7A-7E illustrate embodiments of a robotic end effector to handle baggage.

FIG. 8 illustrates an embodiment of a robotic end effector to handle baggage.

FIGS. 9A and 9B illustrate an embodiment of a robotic system to handle baggage.

FIGS. 10A and 10B illustrate an embodiment of a robotic system to handle baggage.

FIGS. 11A and 11B illustrate an embodiment of a robotic system to handle baggage.

FIG. 11C illustrates an embodiment of a robotic end effector to handle baggage.

FIG. 12 is a flow diagram illustrating an embodiment of a process to use one or more robots to handle baggage.

FIG. 13 is a block diagram illustrating an embodiment of a robotic system to handle baggage.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A robotic baggage handling system is disclosed. The term “baggage” is used herein to refer to passenger suitcases and other checked bags, parcels checked as bags, and other items checked to a destination and handled by the baggage handling personnel, equipment, and/or systems. Baggage may include cargo, and systems and techniques described in herein with reference to “baggage” apply equally to “cargo” and other items that may be shipped to a destination. “Baggage” is described in the context of an airport, in certain examples described herein, but the baggage handling techniques, equipment, and systems disclosed herein may be applied to baggage handling in other contexts, including without limitation in terminals associated with other modes of transportation, such as buses, trains, and ships.

In various embodiments, a robotic system as disclosed herein is used for robotic baggage handling at airports or other transportation and/or baggage handling facilities for multiple operations, including one or both of unloading from trolleys/ULDs (Unit Load Device) or similar equipment to conveyor belts in indoor/outdoor environments in a variety of weather and loading from belts into trolleys/ULDs/similar equipment in indoor/outdoor environments.

In various embodiments, the baggage/cargo loading process is automated using a combination of robotics arms, sensors, computers/processors, mobile platforms, scanners, conveyors, AI based software, etc. In various embodiments, the robot can fit into the existing sites, such as legacy airport baggage handling systems, equipment, and facilities, and new sites can be designed based on robotic systems and techniques disclosed herein.

In various embodiments, one or more of the following baggage handling operations may be performed by a robotic system as disclosed herein: pick/place baggage from belt loader to trolley, ULD, or other container or conveyance; load outbound baggage arriving via airport baggage handling conveyor onto trolley/ULD; and load baggage from trolley to belt loader that conveys bags to or near aircraft cargo hold.

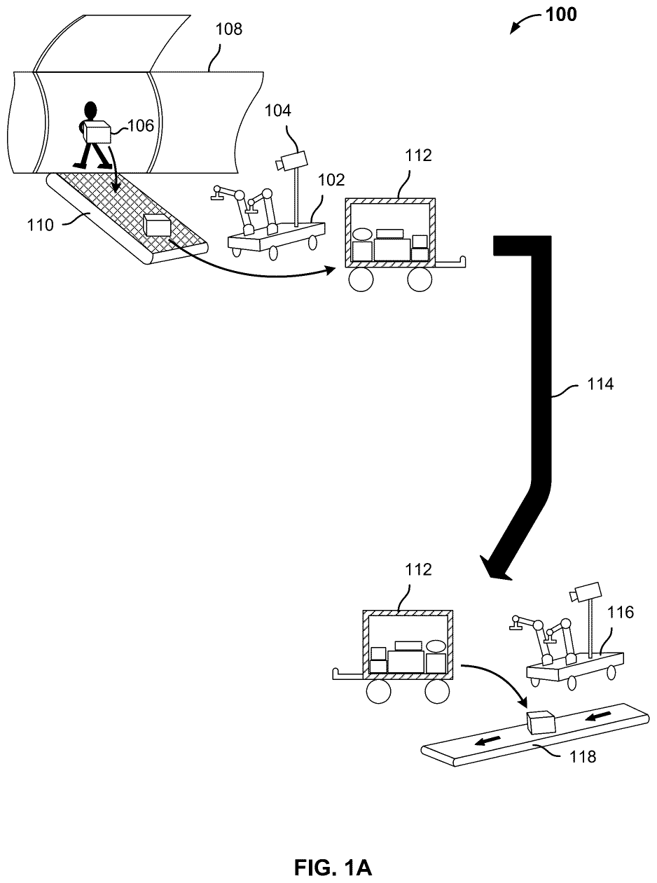

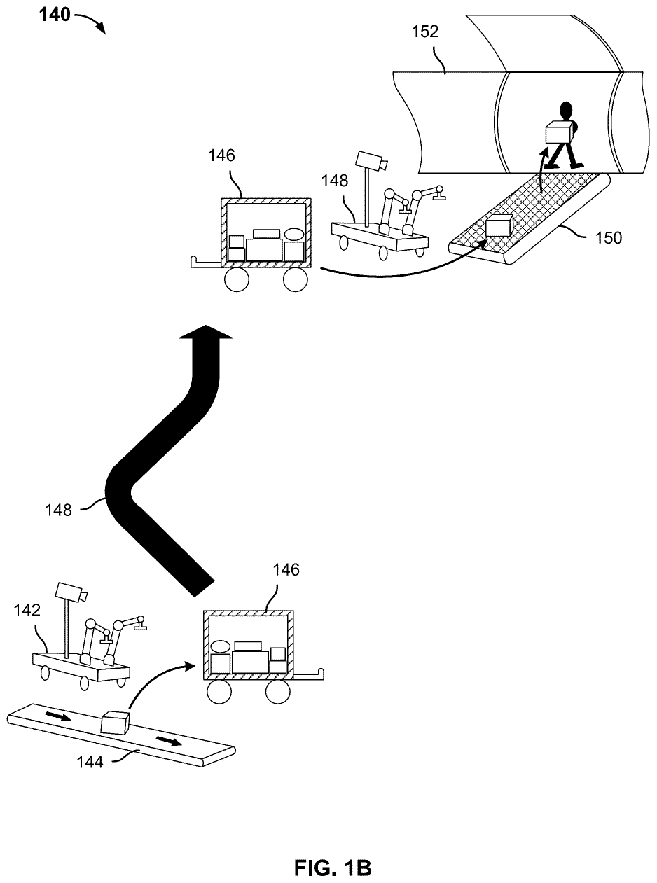

FIG. 1A is a diagram illustrating an embodiment of a robotic system to handle baggage for an arriving flight. In the example shown, system 100 includes a mobile robot 102 equipped with two robotic arms and a pole-mounted camera 104. A control computer, not shown in FIG. 1A, may be included on robot 102 and/or may be provided as a separate computer, e.g., mounted on mobile 102 and/or located remotely. In this example, a human worker is shown placing an item 106 taken from the cargo/baggage hold of aircraft 108 onto a belt loader 110 that is running in the direction down and away from the aircraft. Robot 102 uses image data from camera 104 to detect and track items as they advance down the conveyor 110. Each item is grasped by robot 102 and placed in a baggage trolley 112.

In various embodiments, robot 102 and/or a local or remote control computer uses image data from camera 104 and/or other cameras/sensors to construct and maintain a three-dimensional view of the work area that includes aircraft 108, conveyor 110, and trolleys such as trolly 112. Human workers or other robotic workers may place empty trolleys, such as trolley 112, in position to be filled, e.g., as other trolleys become full and are moved away from the vicinity of conveyor 110. Empty trolleys may arrive by a human operated or robotic tractor pulling a train comprising multiple linked trolleys. The train may be advanced as each trolley is filled.

In various embodiments, robot 102 makes and/or implements a plan to pick items from conveyor 110 and place them in a trolley, such as trolley 112, to create a stable, reasonably densely packed stack of items. The size, weight, rigidity, current/possible orientations, etc. of each arriving item may be determined, and such attributes may be used to plan a sequence of placement and/or placement location for each item. Lighter and less rigid items may be placed initially in a buffer location, e.g., on the ground, until a layer or layers of larger and/or heavier items have been stacked in the trolley. Once the trolley is partially or nearly full, the lighter and/or less rigid items may be packed on top.

For each item, one or more attributes and/or features may be determined, e.g., using images from camera 104. For example, handles, protrusions, may be detected and considered as potential grasp points for a robotic arm. In some embodiments, gripper type end effectors may be used to grasp bags by straps or handles, for example. In some embodiments, a suction type gripper may be used to grasp a rigid or semirigid suitcase, box, etc., for example by applying suction to a side or top surface. In some embodiments, a set of one or more grasp strategies may be considered for a given item, and for each strategy a score may be assigned, e.g., to reflect likelihood of success, energy or time required to make the grasp, etc. The grasp strategy with the best score may be selected.

In various embodiments, machine learning, generative artificial intelligence, and/or other techniques may be used to learn or generate grasp strategies for items, e.g., based on size, weight, rigidity, external features (e.g., handle or strap), etc. As grasp strategies are used successfully, the robotic system learns to apply those strategies in similar future situations, e.g., to items having the same or similar characteristics.

Referring further to FIG. 1A, once the trolley 112 (and other trolleys) has been loaded, the trolley 112 is towed, in this example along path 114, to an airport baggage handling location at which another robot 116 (or, in some embodiments, the same robot 102) is used to pick items from trolley 112 and place them singly on conveyor 118, which carries the bags ultimately to the correct baggage claim location, e.g., a carousel associated with bags arriving via a flight with which aircraft 108 is associated.

FIG. 1B is a diagram illustrating an embodiment of a robotic system to handle baggage for an outbound flight. In the example shown, system 140 includes robot 142 used to pick baggage from an outbound baggage conveyor 144 and place each in trolley 146.

In various embodiments, robot 142 may use image data generated by its pole-mounted camera and/or other sensors (e.g., RFID, fixed camera mounted in the workspace, etc.) to determine which bags arriving via conveyor 144 are associated with a destination with which trolley 146 is associated.

Once loaded, trolley 146 is towed along path 148 to a location in the vicinity of aircraft 152, where robot 148 unloads items from trolley 146 and places each on conveyor 150, which in this example carries each item to a location adjacent to aircraft 152 from which a human worker picks each item up and places it in the baggage hold of aircraft 152.

While in the examples shown in FIGS. 1A and 1B a trolley 112, 146 is described as being loaded/unloaded, in various embodiments the techniques described may be applied to bags or other items being loaded into or removed from a ULD or other container.

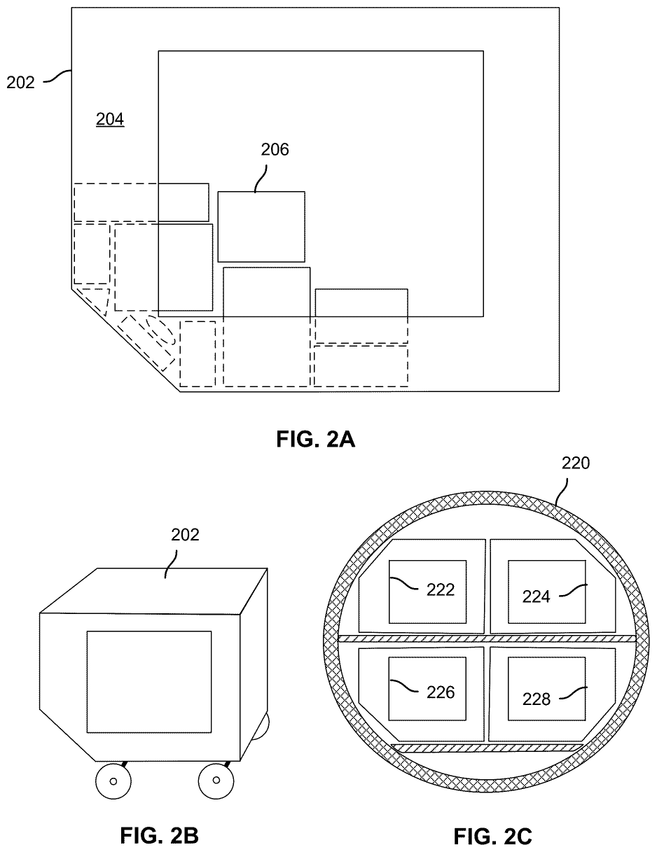

FIG. 2A illustrates an example of a partially loaded Unit Load Device (ULD). In the example shown, ULD 202 includes a side panel 204 that defines an opening through which items 206 may be loaded into or removed from the ULD 202. The ULD 202 includes an angled face, shown at bottom left, which conforms in part to the shape of the aircraft fuselage. The opening defined by side panel 204 is smaller than the entire area of the side panel 204, which results in voids being defined in the interior of ULD 202, as indicated by the dotted lines of those items (or portions of items) 206 not visible from the side view shown. In various embodiments, a robotic system as disclosed herein may use one or more robotic arms to reach into the ULD to load or unload items, such as to place an item into a void or to grasp and remove an item from a void.

In various embodiments, to enable the contents of ULD or other container to be viewed more clearly a camera is mounted on the wrist of the robot arm. When the arm reaches inside, the wrist camera will have a much better view of the container contents (e.g., than relying solely on a camera from the outside).

In various embodiments, a robotic system as disclosed herein applies a packing algorithm and/or other logic to determine a plan to stack items into a ULD or other container, including by considering the need to reach into the container to place items and the interior topography of the container, such as the angular void area shown at bottom left in FIG. 2A.

FIG. 2B shows a perspective view of a ULD on or comprising a mobile base. In the example shown, ULD 202 of FIG. 2A is shown to include and/or to have been placed and secure on a mobile based. For example, the wheels shown at bottom may be integrated with the ULD 202 or the ULD 202 may have been placed and secured on a wheeled flat bed or frame. In various embodiments, multiple ULDs may be connected in a train and towed from a baggage handling area to an aircraft to be loaded onto the aircraft or towed from an aircraft from which the ULDs have been unloaded to a baggage handling area.

FIG. 2C illustrates an example of ULDs loaded in the cargo holds of an aircraft, shown in cross-section. In the example shown, ULDs represented by ULDs 222, 224, 226, and 228 have been loaded into a aircraft 220, shown in cross section. In various embodiments, ULDs may be loaded into an aircraft, such as aircraft 220, via a loading door and pushes or otherwise conveyed into the cargo bay, with additional ULDs being added until full. In the example shown in FIG. 2C, ULDs are loaded in upper and lower cargo areas. In a passenger aircraft, for example, ULDs may be loaded only into a lower cargo area on the underside of the aircraft, which seats, restrooms, and other service areas may be located in the upper portion.

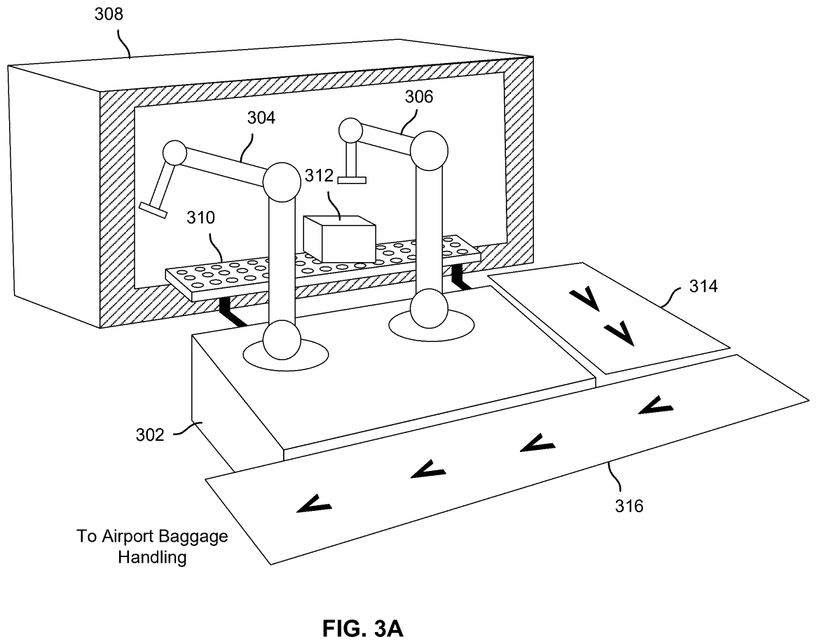

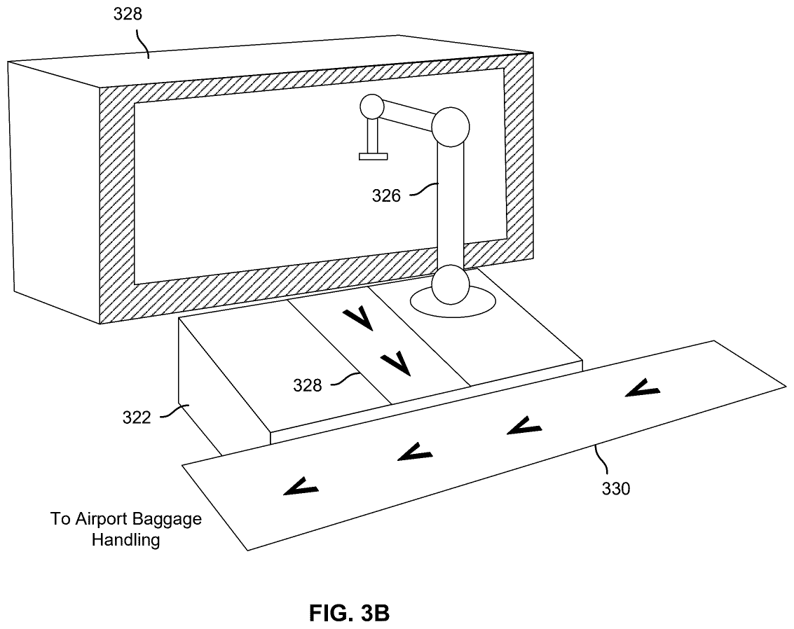

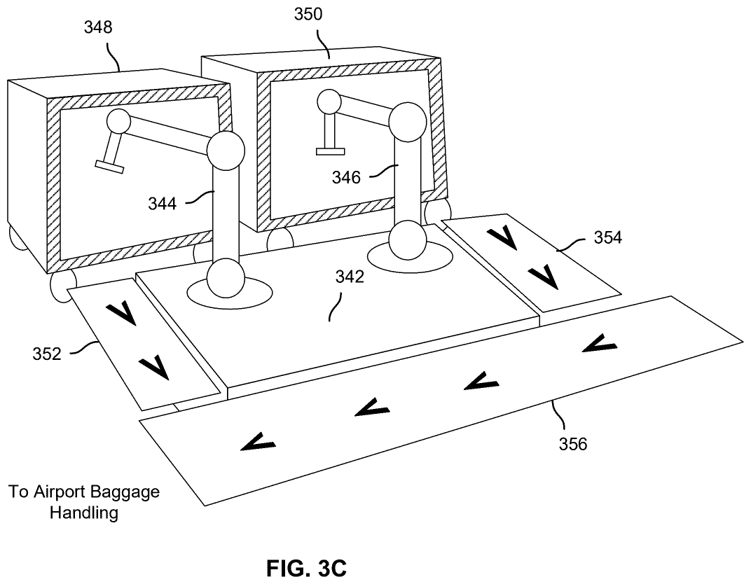

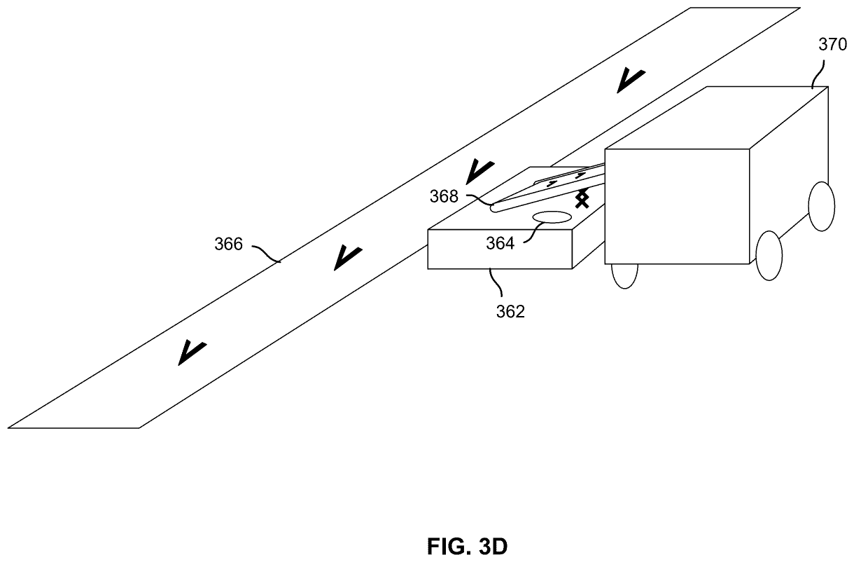

FIG. 3A is a diagram illustrating an embodiment of a robotic system to handle baggage. In the example shown, robot 302 uses robotic arms 304 and 306 to unload baggage from container 308, e.g., a trolley or ULD. Robotic arms 304 and 306 place items on omni-directional ball conveyor 310, which is operated under robotic control to convey items, such as item 312, to a transfer conveyor 314 positioned to the side of robot 302, which in turn conveys each item to conveyor 316, which comprises and/or carries items to the airport baggage handling system for arriving baggage.

In various embodiments, the height of one or both of ball conveyor 310 and transfer conveyor 314 may be adjusted, e.g., to facilitate placement of items onto ball conveyor 310 by robotic arms 304 and 306. For example, while the robotic arms 304 and 306 are unloading items from the top of container 308, the ball conveyor 310 may be raised to a height to facilitate placement of items. As items are unloaded, the ball conveyor 310 may be lowered to a level appropriate for the height at which items then being picked by the robotic arms 304, 306 are located.

In some embodiments, ball conveyor 310 may once loaded be lowered to a height of transfer conveyor 314 or, alternatively, at least the end of transfer conveyor 314 that is nearest to the ball conveyor 310 and/or container 308 may be elevated to a same height as ball conveyor 310. In this way, robot 302 and associated auxiliary equipment may be used with a legacy container 308 or any dimensions and a legacy baggage handling conveyor 316 at any height.

In some embodiments, the height above ground of the shoulder joints of the robotic arms 304, 306 similarly may be adjusted, e.g., as required to accommodate a given container 308 and/or baggage handling conveyor 316. For example, hydraulics may be used to raise or lower the upper surface of robot 302, on which robotic arms 304, 306 are mounted.

FIG. 3B is a diagram illustrating an embodiment of a robotic system to handle baggage. In the example shown, robot 322 includes robotic arm 326 positioned to unload baggage from container 328. Robotic arm 326 place items onto transfer conveyor 328 located between them, which in turn carries items to the baggage handling conveyor 330.

In some embodiments, robot 322 comprises a robotically-controlled mobile chassis which may be used to move side to side in front of the container 328, or to move laterally from one container to another, to enable robotic arm 326 to reach and grasp items to be placed onto to transfer conveyor 328.

In some embodiments, robot 322 may include one or more additional robotic arms in addition to robotic arm 326. The robotic arms may be used cooperatively to simultaneously grasp an item and place it on to transfer conveyor 328, e.g., to unload an item that is too heavy and/or bulky to be handled safely by a single robotic arm.

In various embodiments, transfer conveyor 328 may be an integrated part of robot 322. In other embodiments, transfer conveyor 328 may be positioned alongside robot 322.

In various embodiments, transfer conveyor 328 may be operated under robotic control. For example, computer vision may be used to identify an available space on conveyor 330 and transfer conveyor 328 may be advanced with robotically controlled timing and/or speed to inject the next item onto conveyor 330.

In various embodiments, transfer conveyor 328 includes articulating segments to facilitate moving the distal end of the transfer conveyor 328 in and out of the container. For example, the transfer conveyor 328 may be moved in or out of the conveyor, as needed, to minimize the amount of time the arm needs to land the bag onto the belt, so as to decrease cycle time.

FIG. 3C is a diagram illustrating an embodiment of a robotic system to handle baggage. In the example shown, robot 342 includes robotic arms 344, 346 each positioned to unload from a corresponding container 348, 350, such as a trolley or ULD. Each robotic arm 344, 346 places items on an associated transfer conveyor 352, 354 positioned alongside robot 342 on the same side as that robotic arm 344, 346. The transfer conveyors 352, 354 transfer items onto baggage conveyor 356.

The system shown in FIG. 3C enables multiple containers (trolleys, ULDs, etc.) to be unloaded (or loaded) at the same time. For example, a train of containers could be pulled up alongside the robot 342 (or multiple robots), and unloaded simultaneously.

FIG. 3D is a diagram illustrating an embodiment of a robotic system to handle baggage. In the example shown, robot 362 includes one or more robotic arms, represented in FIG. 3D by robotic arm mount location 364 to avoid obscuring other features. Robot 362 is positioned to unload from container 370. Robot 362 uses its one or more robotic arms to unload items from container 370, placing each on transfer conveyor 368, which conveys each to baggage conveyor 366. As shown in FIG. 3D, in this example transfer conveyor 368 includes a scissor-type lift mechanism to raise/lower the container-side end of transfer conveyor 368, e.g., to position the container-side end at a height appropriate for the height from which the robotic arm(s) is/are unloading items from container 370. For example, in the position shown, the robotic arm(s) may be being used to unload items from at or near the top, or in the upper half, of container 370. As the container 370 is unloaded and the final items are pulled from the lower part of the container 370, the transfer conveyor 368 may be lowered to a corresponding height.

While the examples shown in FIGS. 3A-3D are described above in connection with an unloading operation, in various embodiments the same systems, structures, and techniques may be used to load a container, such as a trolley or ULD, e.g., by pulling items from a baggage conveyor or transfer conveyor to place in the container. In some embodiments, another robot, human worker, automated pusher, or other mechanism may be used to inject items from an outbound baggage conveyor to a transfer conveyor, e.g., as shown in FIGS. 3A-3D but operating in the opposite direction, and a robotic arm may be used to pick each item from the transfer conveyor and load it into the container.

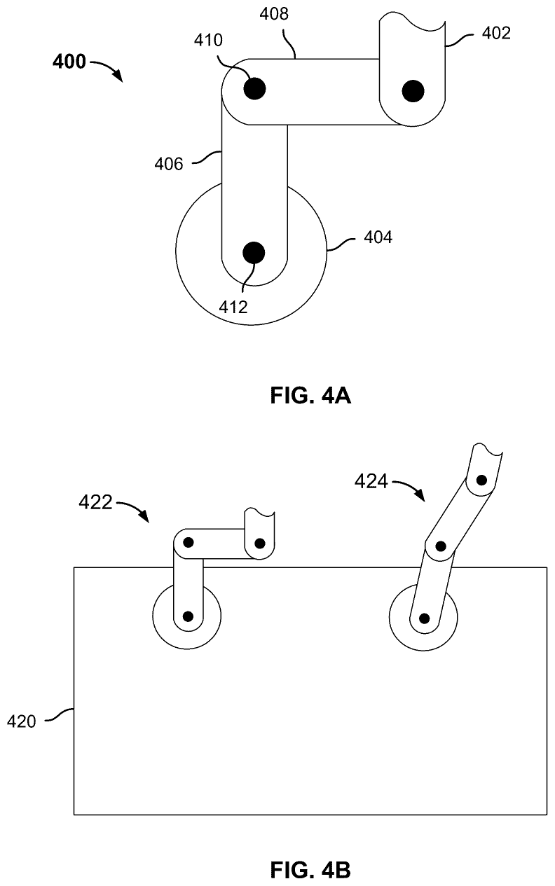

FIG. 4A is a diagram illustrating a robotic arm shoulder positioning mechanism used in an embodiment of a robotic system to handle baggage. In various embodiments, the robotic arm shoulder positioning mechanism 400 of FIG. 4A may be used to extend the reach of a robotic arm, e.g., to enable the arm to be used to reach into a ULD or other container to load or unload baggage.

In the example shown, robotic arm shoulder positioning mechanism includes a base link 402 on which a robotic arm may be mounted, such as a 6 degree of freedom (6-DOF) or other n-DOF robotic arm. Base link 402 is connected via links 406 and 408 and intervening joints 410 and 412 to a shoulder mount 404 on a mobile or stationary robot chassis. In some embodiments, the aforementioned n-DOF robotic arm is mounted on the bask link 402, and the added joints 410 and 412 provide additional degrees of freedom and the ability to extend the arm towards and/or into the container. The n-DOF arm may then be used to manipulate items in the container, such as by grasping a bag and removing it from the container or placing an item more precisely and/or deeper into the container.

FIG. 4B is a diagram illustrating an embodiment of a robotic system to handle baggage that incorporates a robotic arm shoulder positioning mechanism for each of two robotic arms. In the example shown, robot 420 includes two robotic arms, one mounted on robotic arm shoulder positioning mechanism 422 and the other mounted on robotic arm shoulder positioning mechanism 424.

In some embodiments, a robotic arm shoulder positioning mechanism such as those shown in FIGS. 4A and 4B may be used to position the shoulder joint of an n-DOF robotic arm mounted thereon in a position nearer to and/or in a trolley or ULD. In some embodiments, all degrees of freedom (e.g., the n degrees of freedom of the robotic arm and the degrees of freedom added by the robotic arm shoulder positioning mechanism are controlled in an integrated manner, to fluidly move the end effector and operative links on the distal end of the robotic arm in and out of the container as needed to load/unload.

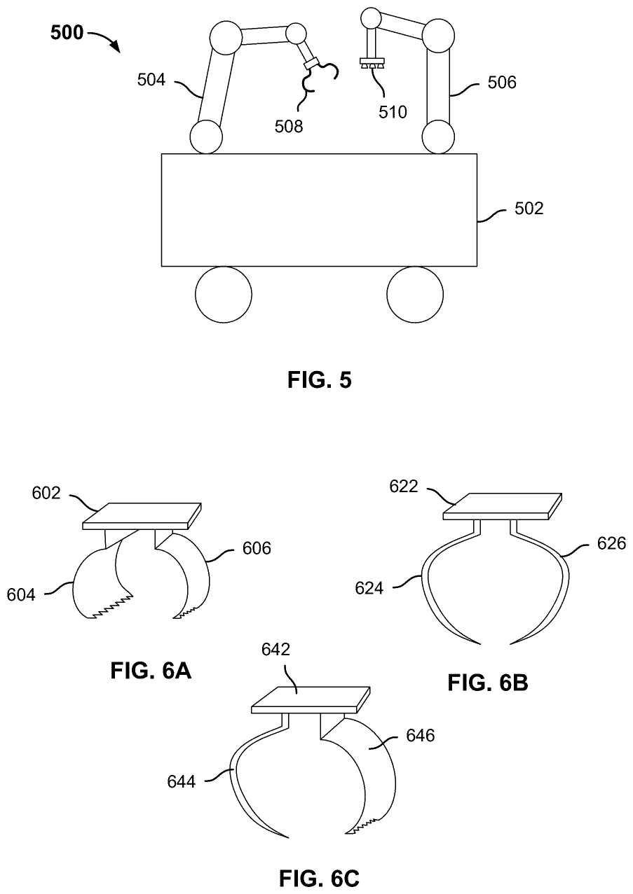

FIG. 5 is a diagram illustrating an embodiment of a robotic system to handle baggage that includes robotic arms having dissimilar types of end effector. In the example shown, robot 500 includes a mobile chassis 502 and robotic arms 504 and 506 equipped with dissimilar type end effectors 508 and 510. In the example shown, end effector 508 is a claw or gripper type end effector while end effector 510 is a suction type end effector.

In various embodiments, a control computer comprising and/or configured to control robot 502 may determine for each item of baggage to be handled that one or other of end effectors 508, 510 should be used to grasp the item. For example, to grasp a soft bag with a strap or handle the gripper type end effector 508 may be selected. By contrast, to grasp a hard-side suitcase or box the suction type end effector 510 may be preferred.

The mobile chassis 502 may be controlled as/if needed to position the corresponding robotic arm 504, 506 into a position to grasp the item using the selected end effector 508, 510. In some embodiments, in cases in which either end effector 508, 510 may have a feasible grasp strategy, the cost to reposition the mobile chassis 502 and/or robotic arm 504, 506 may be taken into consideration in determining with arm and end effector to use. For example, a strategy that is slightly less likely to be successful but does not require the chassis 502 to be moved may be selected.

FIGS. 6A-6C illustrate embodiments of a robotic end effector to handle baggage. In the example shown in FIG. 6A, the end effector includes a mounting plate 602 and partial cylinder-shaped opposing claws 604 and 606, each with a serrated leading edge, in this example. In various embodiments, the claws 604 and 606 may be opened and closed independently, together, or selectively singly or together. In some embodiments, the claws may be interlinked mechanically in such a way that they also open or close together.

FIG. 6B shows a claw/gripper type end effector comprising a mounting plate 622 and opposing pincer-shaped grippers 624 and 626. FIG. 6C, meanwhile, shows an end effector comprising a mounting plate 642 with opposing gripper elements 644, 646, one comprising a pincer 644 and the other a partial cylinder-shaped claw 646.

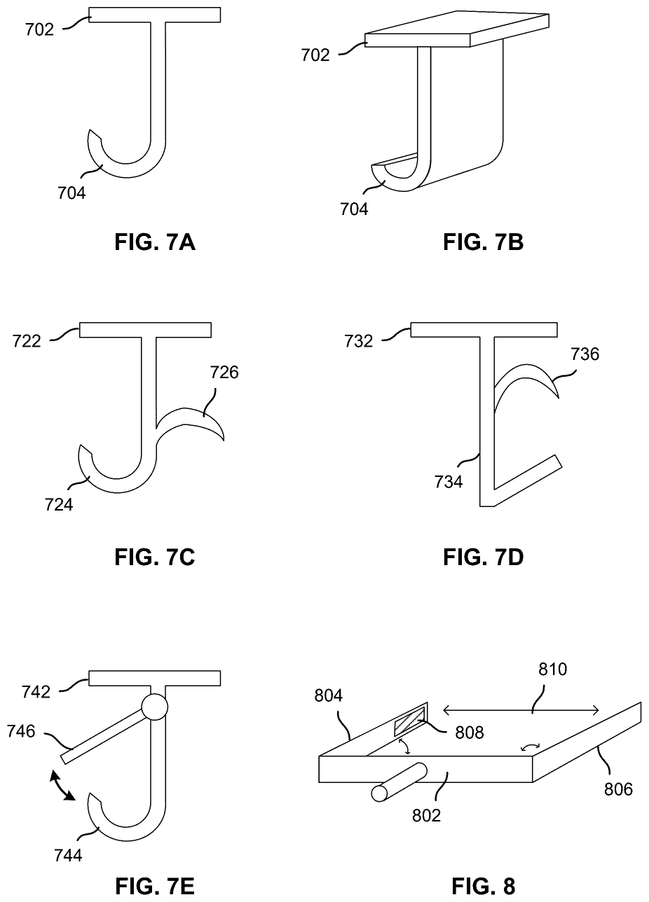

FIGS. 7A-7E illustrate embodiments of a robotic end effector to handle baggage. For example, FIG. 7A shows a “J” hook shaped end effector comprising a mounting plate 702 and hook 704. FIG. 7B shows the “J” hook end effector of FIG. 7A in perspective view. A “J” hook having depth (or width) as shown in FIG. 7B may be used to engage a suitcase handle or strap more securely that a simple, more two-dimensional design.

FIG. 7C shows a variant that includes a mounting plate 722 and an upward turning “J” hook 724 with an added downward turning hook 726. The hook 726 may be used, for example, to engage a handle or strap from above, such as to pull a bag from the top of a pile and move it to a position to be grasped.

FIG. 7D shows a further variant comprising a mounting plate 732, an upward turned “V” hook 734 and a downward turned hook 736 on the same side as the “V” hook 734. The variant shown in FIG. 7D may enable a bag to be engage with one hook then the other in succession, without having to rotate the end effector.

FIG. 7E shows a “J” hook comprising a mounting plate 742, “J” hook 744, and a locking mechanism 746. For example, the locking mechanism 746 may be closed once a bag has been grasped using the “J” hook 744, making the grasp more secure as the bag is moved through a trajectory to its destination. In various embodiments, a locking mechanism such as locking mechanism 746 may be integrated into one or more of the end effectors shown in FIGS. 7A through 7D.

FIG. 8 illustrates an embodiment of a robotic end effector to handle baggage. In the example shown, the end effector includes a cross member 802 and opposing arms 804 and 806. Friction pads 808 are positioned on the inside surface of the arms 804, 806. The arms 804, 806 may be moved nearer or further apart, as indicated by the arrow 810, as needed to be positioned on either side of and then closed together to grasp an item of baggage. In the example shown, one or both arms may be swung out of the way as/if needed to position the end effector across an item to be grasped. Once in position, the arm that was opened may be swung closed and the arms moved nearer together, e.g., by a robotically controlled linear actuator, to grasp the item of baggage.

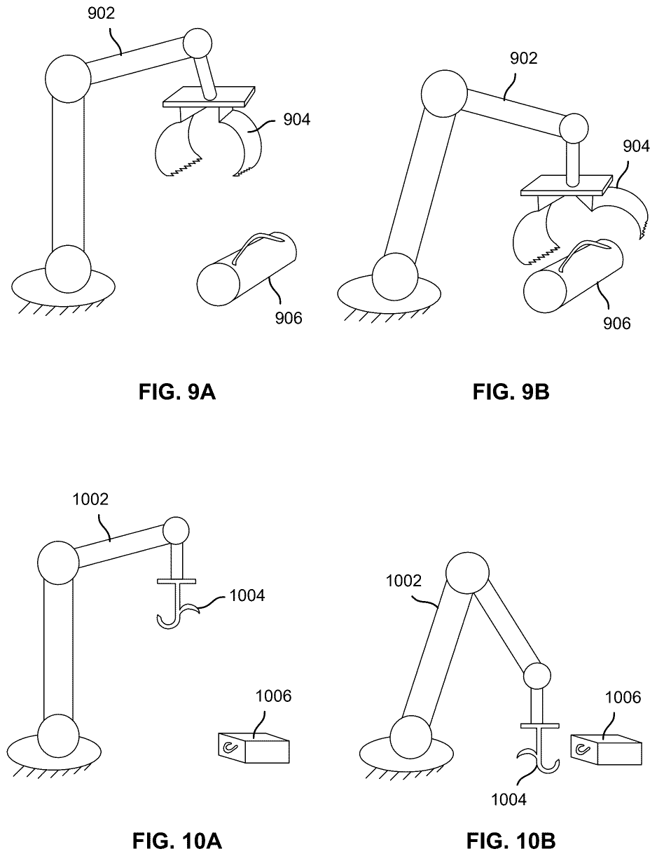

FIGS. 9A and 9B illustrate an embodiment of a robotic system to handle baggage. In the example shown, robotic arm 902 with claw type end effector 904 (e.g., as shown in FIG. 6A) is used to grasp a bag 906. The robotic arm 902 is used to position the end effector 904 near the bag 906. One of the claws comprising end effector 904 is open, e.g., using a robotically controlled actuator, enabling the other claw to be positioned alongside the bag 906 prior to closing the previously opened claw to grasp the bag.

FIGS. 10A and 10B illustrate an embodiment of a robotic system to handle baggage. In the example shown, robotic arm 1002 with “J” hook type end effector 1004 (e.g., as shown in FIG. 7C) is used to grasp bag 1006. The robotic arm 1002 is used to rotate the end effector to place the upward turned “J” hook into position to engage a handle of the bag 1006, e.g., by hooking the handle from below.

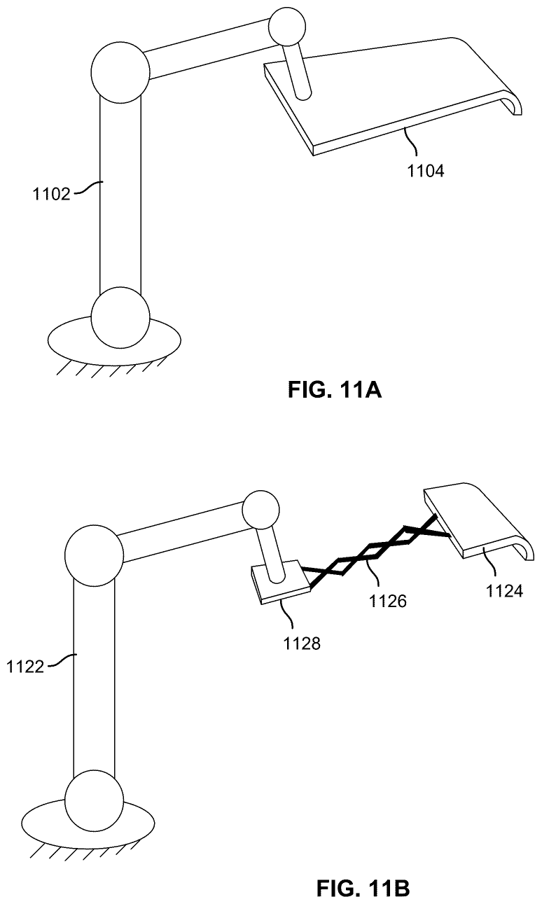

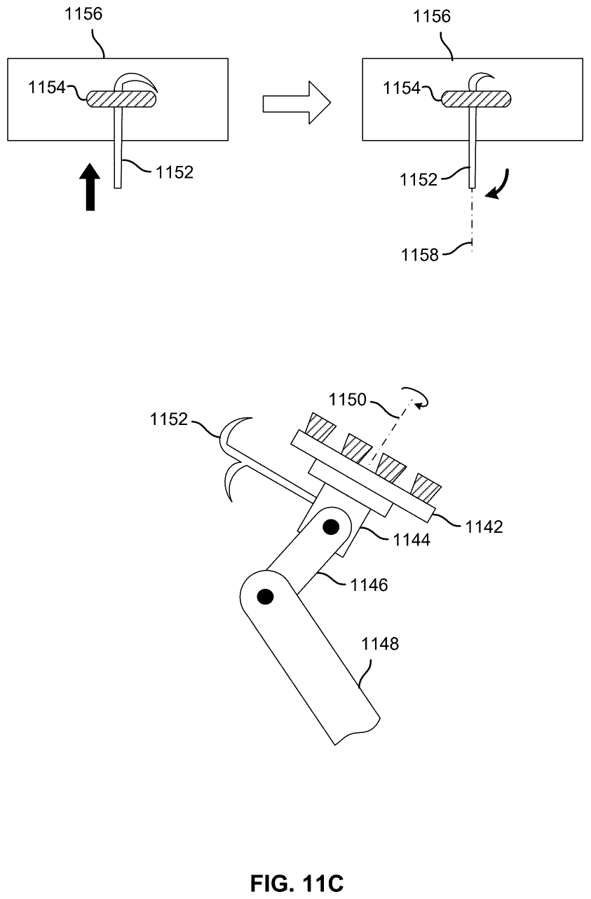

FIGS. 11A and 11B illustrate an embodiment of a robotic system to handle baggage. FIG. 11A shows a robotic arm 1102 with end effector 1104, which comprises an elongated plate extending away from the location at which the end effector 1104 is mounted to robotic arm 1102 and which terminates in a downward curled lip. In various embodiments, end effector 1104 may be extended into a trolley, ULD, or other container and used to pull items out of the container, e.g., by using the downward curled lip to engage a far edge and/or back side of the item.

FIG. 11B shows a functionally similar design to the end effector of FIG. 11A, except that the end effector mounted on robotic arm 1122 includes a smaller, less elongated plate 1124, still with a downward curled lip at the distal end, connected to robotic arm 1122 via an extension/retraction mechanism 1126 and mounting plate 1128. The extension mechanism 1126 may be extended to reach back into a trolley or ULD, for example, then retracted to pull an item from the back of the trolley or ULD.

FIG. 11C illustrates an embodiment of a multi-mode robotic end effector to handle baggage. In the example shown, the robotic end effector includes a suction section 1142 connected via a rotatable gripper base 1144 and a mobile gripper wrist 1146 to a robotic arm 1148. The rotatable gripper base 1144 is rotatable about z-axis 1150 to position a flat hook 1152 affixed to the side of gripper base 1144.

Flat hook 1152 includes a shaft portion that extends radially away from the gripper base 1144 and in this example two flat hooks at or near the distal end, hooking away from the shaft portion in opposite directions.

The drawings at the top of FIG. 11C illustrate operational use of the flat hook 1152, in various embodiments. Specifically, the drawing at upper left shows the flat hook being slid under/through handle 1154 of bag 1156 with its flat profile substantially parallel to the top surface of bag 1156 (viewed from the top as shown). The drawing at upper left shows the flat hook then being rotated about its longitudinal axis 1158 to cause its hooked end to point substantially upwards, as shown, enabling the robotic arm 1148 to be used to use the hooked end of flat hook 1152 to engage the handle 1154 and thereby pull and/or lift the bag 1156.

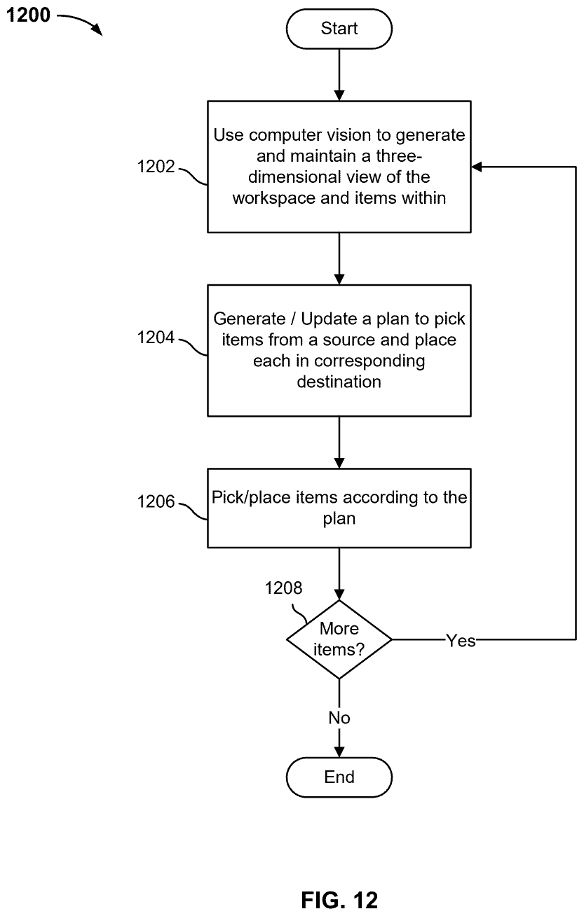

FIG. 12 is a flow diagram illustrating an embodiment of a process to use one or more robots to handle baggage. In various embodiments, process 1200 may be performed by a processor comprising a robotic system as disclosed herein, such as a control computer and/or a computer or other processor comprising a robot as disclosed herein. In the example shown, at 1202 computer vision is used to generate and maintain a three-dimensional view of the workspace and items within. For example, image data from a camera mounted on a baggage handling robot and/or in a baggage handling area may be used to generate images. The images may be used to generate and maintain a three-dimensional view of the workspace and baggage to be handled. Video segmentation may be performed to identify relevant objects, such as individual bags, as well as their visible features (e.g., straps, handles, voids, protrusions, and other features that might accommodate a grasp). Lookups and/or computations may be performed to determine item attributes, such as rigidity, weight, etc. Heavy items might be identified, e.g., by reading or otherwise decoding an express marking, such as a tag, or by looking item specific data, such as a weight recorded when the bag was checked or loaded.

At 1204, a plan to pick items from a source and place each in corresponding destination is generated and/or updated. For example, for each item being unloaded from an aircraft, a plan may be generated to use a robotic arm and end effector to grasp the item, move it through a planned trajectory, and place it in a selected destination location, for example a place in or on a stack of items being built in or on a trolley, ULD, or other container. The planning may include using a packing algorithm to determine for each item a corresponding placement in or on the stack.

At 1206, items are picked, moved, and placed according to the plan, as/if updated.

Steps 1202, 1204, and 1206 are repeated as necessary until it is determined at 208 that all items have been placed, e.g., the last bag has been loaded onto a trolley or into a ULD or other container, at which point the process ends.

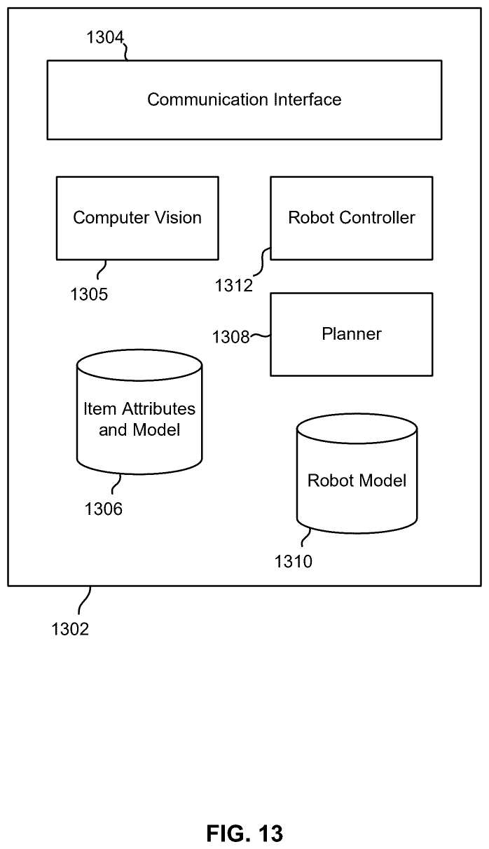

FIG. 13 is a block diagram illustrating an embodiment of a robotic system to handle baggage. In various embodiments, the robotic control system 1302 may comprise one or both of a control computer separate from a robot and a controller or other computer comprising the robot. In the example shown, system 1302 includes a communication interface 1304, e.g., an Ethernet, EtherCat, WiFi, Bluetooth and/or other network or near field communication interface, configured to send/receive commands and information, such as image data or other sensor information.

Computer vision module 1305 uses image data received via communication interface 1304 to generate/update a three-dimensional view of at least relevant parts of a workspace, such as a baggage handling area near an aircraft or in an airport baggage handling facility. Item attributes and model 1306 may include information such as the dimensions, weight, and rigidity of specific and/or types of items and for each a set of grasp strategies available to grasp and move the item (or items of that type).

Planner module 1308 may use information from computer vision module 1305 and item attributes and model 1306 to generate and/or update a plan to pick and place items as required to achieve a high level objective, such as to unload bags from an aircraft and load them into one or more trolleys for transport to an airport baggage handling facility or load bags arriving via a baggage conveyor onto trolleys or into a ULD for transport and loading onto an aircraft. Planner 1308 may use robot model(s) 1310, e.g., kinematic models of one or more robotic comprising the system, to generate plans to grasp, move, and place items.

Robot controller 1312 receives plans from planning module 1308 and three-dimensional view data from computer vision module 1305 and uses the information to generate and send commands to control one or more robotic arms (and/or other robotic instrumentalities, such as a robotically controlled mobile chassis, as applicable) to implement the plans and accomplish the high-level objective.

In various embodiments, robot controller 1312 may send high level commands to a robot controller comprising individual robotic elements, such as a robotic arm. The local controller may then send lower level commands to joint motor drivers, for example, to effectuate the higher level commands.

In various embodiments, structures and techniques disclosed herein may be used to provide a robotic system to load and/or unload baggage autonomously in an airport setting.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic baggage handling system, comprising:
a communication interface configured to receive data from one or more sensors; and
a processor coupled to the communication interface and configured to:
use sensor data received via the communication interface from the one or more sensors to generate a three-dimensional view of a baggage handling workspace; and
use the generated three-dimensional view of the baggage handling workspace to generate and implement a plan to use one or more robotic arms to pick and place baggage items as needed to do one or both of (1) load baggage items from a first baggage conveyor into or onto a trolley, Unit Load Device (ULD), or other container; and (2) remove baggage items from a trolley, Unit Load Device (ULD), or other container and place each on a second baggage conveyor.

2. The system of claim 1, wherein the first baggage conveyor comprises an aircraft loading and unloading conveyor configured to be positioned with a first end near an airport baggage hold door and a second end near the tarmac.

3. The system of claim 2, wherein the first baggage conveyor carries baggage items from the tarmac to the aircraft baggage hold door during a loading operation in preparation for aircraft departure.

4. The system of claim 2, wherein the first baggage conveyor carries baggage items from the aircraft baggage hold door to the tarmac during an unloading operation in connection with aircraft arrival.

5. The system of claim 1, wherein the second baggage conveyor comprises an airport baggage handling system conveyor configured to carry bags to an outbound baggage handling area for further conveyance to and loading onto a departing aircraft.

6. The system of claim 1, wherein the second baggage conveyor comprises an airport baggage handling system conveyor configured to carry bags from an arriving flight to a baggage claim area or equipment.

7. The system of claim 1, further comprising a transfer conveyor on which the one or more robotic arms place baggage items removed from the trolley, Unit Load Device (ULD), or other container and wherein the transfer conveyor is positioned and configured to further convey the baggage items onto the second baggage conveyor.

8. The system of claim 7, wherein the robotic baggage handling system comprises two robotic arms mounted on a base or chassis and the transfer conveyor is positioned at a side of the base or chassis.

9. The system of claim 7, wherein the robotic baggage handling system comprises two robotic arms mounted on a base or chassis, the transfer conveyor comprises a first transfer conveyor positioned on a first side of the base or chassis, and the robotic baggage handling system further comprises a second transfer conveyor positioned on a second side of the base or chassis opposite the first side.

10. The system of claim 7, wherein the robotic baggage handling system comprises two robotic arms mounted on a base or chassis and the transfer conveyor is positioned between the robotic arms.

11. The system of claim 7, further comprising a ball conveyor or other omnidirectional conveyor configured to convey baggage items onto the transfer conveyor.

12. The system of claim 11, wherein the ball conveyor or other omnidirectional conveyor is adjustable in height and the processor is configured to control a height adjustment mechanism of the ball conveyor or other omnidirectional conveyor to position the ball conveyor or other omnidirectional conveyor at a height that optimizes unloading given a current height from which items are being picked from the trolley, Unit Load Device (ULD), or other container.

13. The system of claim 1, wherein the robotic baggage handling system comprises a robotic arm that is coupled to a base or chassis via a robotic arm shoulder positioning mechanism that adds one or more additional degrees of freedom to those of the robotic arm.

14. The system of claim 13, wherein the robotic arm shoulder positioning mechanism comprises a pair of extension links connected to each other by a robotic joint and affixed at a proximal end to a mounting location on the base or chassis and at a distal end to the should or base of the robotic arm.

15. The system of claim 13, wherein the robotic arm shoulder positioning mechanism enables the shoulder of the robotic arm to positioned nearer to or in the trolley, Unit Load Device (ULD), or other container.

16. The system of claim 1, wherein the robotic system includes two robotic arms having dissimilar types of robotic end effectors.

17. The system of claim 16, wherein a first end effector comprises a gripper type end effector and a second end effector comprises a suction type end effector.

18. The system of claim 17, wherein the processor is further configured to select which end effector will be used to grasp a given baggage item.

19. The system of claim 18, wherein the selection is made based at least in part on one or more attributes of the baggage item.

20. The system of claim 1, wherein the robotic system includes a robotic arm equipped with an end effector that includes a downward curling lip at a distal end and wherein the processor is configured to use the end effector that includes the downward curling lip at the distal end to engage a far edge or side of a baggage item and pull the baggage item towards the robotic arm.

21. A method of controlling a robotic baggage handling system, comprising:
receiving data from one or more sensors; and
using sensor data received from the one or more sensors to generate a three-dimensional view of a baggage handling workspace to generate and implement a plan to use one or more robotic arms to pick and place baggage items as needed to do one or both of (1) load baggage items from a first baggage conveyor into or onto a trolley, Unit Load Device (ULD), or other container; and (2) remove baggage items from a trolley, Unit Load Device (ULD), or other container and place each on a second baggage conveyor.

22. A computer program product to a robotic baggage handling system, computer program product being embodied in a non-transitory computer readable medium and comprising computer instructions for:
receiving data from one or more sensors; and
using sensor data received from the one or more sensors to generate a three-dimensional view of a baggage handling workspace to generate and implement a plan to use one or more robotic arms to pick and place baggage items as needed to do one or both of (1) load baggage items from a first baggage conveyor into or onto a trolley, Unit Load Device (ULD), or other container; and (2) remove baggage items from a trolley, Unit Load Device (ULD), or other container and place each on a second baggage conveyor.
